(19) United States
(12) Patent Application Publication
(10) Pub. No.: US 2009/0273889 A1
(43) Pub. Date: Nov. 5, 2009

(54) Bookfriend electronic bookmark

(76) Inventor: Martin Joseph Markley, Overland Park, KS (US)

Correspondence Address: Martin J. Markley, 12467 Rosehill ST., Overland Park, KS, 66213, US

(21) Appl. No.: 12/229,839

(22) Filed: Sep. 18, 2008

Related U.S. Application Data
(60) Provisional application No. 61/126,143, filed on May 1, 2008.

(51) Int. Cl. H02B 1/00

(52) U.S. Cl. 361/679.01

(57) ABSTRACT

A portable electronic multiple book and multiple page referencing device may be releasably secured to a book cover by spring clips. A thin planar case houses a programmable electronic device accessed by an alphanumeric keypad and other operational keys. References to printed works and related page references are shown on one or two digital displays.

### CROSS-REFERENCE TO RELATED APPLICATIONS

The present utility patent application claims the benefit of provisional application No. 61/126,143, filed May 1, 2008.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to bookmarks and particularly to a portable electronic bookmark which is releasably secured to a book cover for indicating to a user the location where the user was previously reading in a piece of literature having a plurality of pages; the electronic bookmark may hold a plurality of titles and page numbers and comprises a thin planar housing with an alphanumeric keypad, a book title display, a digital page number display, a title insert key, a title lock key, a reference key, a recall key, and a book select key on a front face thereof and one or more high tension mounting spring clips on a back face thereof.

2. Description of Related Art Including Information Disclosed Under 37 CFR 1.97 and 1.98

Book readers find it necessary to mark a book at a selected reference location between reading sessions so that the reader does not have to remember the last page number they read. Readers at times fold a corner of that page, leaving the page damaged, torn or wrinkled. Manual implements have been devised to index the reader's location, but are often lost. The disadvantage of paper clips, of course, is the possibility of damage to pages of the book. Manual page markers which a user sets a page indicating numeric device have been provided in prior art, examples of which may be found in U.S. Pat. Nos. D492,345; D488,832; 6,796,266; 6,390,015; 5,518,409; 5,305,706; 4,608,772; 3,918,390; 1,249,980; 1,018,816 and 168,395. No other device stores multiple book titles, and the pages last read for each book respectively, or multiple pages needed to be referenced at a later time, until this new device, which is unique in its functions. Every student, teacher, and avid reader will demand this new ultra thin electronic bookmark.

While one of the prior patents (U.S. Pat. No. 5,377,612) provides a device which refers to a book title and page number, it operates mechanically. Most of the other book related electronic devices are dictionaries and have a thin portion which acts as a book mark.

U.S. Pat. No. 5,377,612, issued Jan. 3, 1995 to Catalano, discloses a manual device for marking a page of a book and for indicating the number of such page comprising a first sheet of thin rigid opaque plastic material formed in a generally rectangular configuration with long parallel side edges and short parallel upper and lower edges. A second sheet of thin rigid opaque plastic material is formed in a generally rectangular configuration with long parallel side edges and short parallel upper and lower edges, the first of the sheets being formed with a plurality of equally spaced rectangular windows formed between the longitudinal center line of the sheet and a second long edge. A plurality of transparent rigid opaque plastic circular disks are provided, each of the disks being formed with the numbers 0 through 9 adjacent to its periphery for sequentially being positioned adjacent to the windows. A rivet extends through the center of each circular member and through the first and second sheets to allow for rotation of each circular member independent of the other circular members to bring a number into view through the window for indicating the page number of a book being marked, a minor portion of each circle extending beyond the space between the sheets to allow a user to rotate each circular member to thereby change an exposed number. An alternate embodiment is provided having a pull-up flexible marking strip over a layer of marking material on a fixed strip therebeneath. In this manner the name of the book being read may be written on the exterior of the flexible strip by depressing the upper surface of the sheet into contact with the flexible strip with the letters of the book being read. Lifting of the marking strip will separate the marking strip from the marking material in the letter areas to erase the written words.

U.S. Patent Application #20070002024, published Jan. 4, 2007 by Goszyk, describes a portable electronic reference device with pivoting light lid that can be used by a user when reading a book. The electronic reference device functions as a dictionary for the reader to look up words as they read. It can also have various other functions that would be suitable for a portable electronic device. The device has a display section and a keyboard section. A pivoting transparent lid is provided on the display. The lid also contains a light to allow a user to clearly see the device and pages of a book.

U.S. Patent Application #20040249631, published Dec. 9, 2004 by Harris, discloses methods and systems for a credit card-size electronic dictionary configurable as a bookmark or configured to fit in a credit card holder. The electronic dictionary includes a flexible housing configured to accommodate the flexing of a credit card holder. The flexible housing has a length with substantially the same dimension as a credit card length and a height with substantially the same dimension as a credit card width. A flexible dictionary display is configured to display a plurality of words, and a dictionary keyboard is configured to receive user letter entries.

U.S. Patent Application #20020150417, published Oct. 17, 2002 by Yao, claims an electronic bookmark device that can perform multiple functions. The device has a display housing and a thin keypad. The display housing and keypad are sized and connected so that the display housing can rest on the edges of the pages of a book while the keypad is placed between two pages of a closed book. The keys of the keypad are incorporated onto the surface of the keypad such that they do not rise above the general surface of the keypad. The keys of the keypad include multiple function keys that select among dictionary, clock, calculator, schedule/alarm and help features. Additional keys are used for data input including cursor keys, a QWERTY arrangement of alphanumeric keys, and auxiliary keys. Several keys serve dual purposes for use with the various functions of the device.

U.S. Pat. No. 6,424,984, issued Jul. 23, 2002 to Yao, puts forth an electronic bookmark device that can perform multiple functions. The device has a display housing and a thin keypad. The display housing and keypad are sized and connected so that the display housing can rest on the edges of the pages of a book while the keypad is placed between two pages of a closed book. The keys of the keypad are incorporated onto the surface of the keypad such that they do not rise above the general surface of the keypad. The keys of the keypad include multiple function keys that select among dictionary, clock, calculator, schedule/alarm and help features. Additional keys are used for data input including cursor keys, a QWERTY arrangement of alphanumeric keys, and auxiliary keys. Several keys serve dual purposes for use with the various functions of the device.

U.S. Pat. No. D385,300, issued Oct. 21, 1997 to Guise, is for the ornamental design for an electronic book marker.

U.S. Pat. No. 7,260,025, issued Aug. 21, 2007 to Farinella, provides a bookmark that uses an integrated electronic timer circuit to track reading time. A flat substrate marks the page of the book. A header is integral with the substrate. The header has a cavity for housing the electronic timer, a display for displaying the timer count value, and a plurality of control buttons for controlling the electronic timer. A sensor can sense an external condition such as light or touch to control the electronic timer. A light source is provided in the header. The substrate may contain a magnifying viewing port. The electronic timer has a memory for storing the timer count values for individual and cumulative reading sessions.

U.S. Pat. No. 5,093,760, issued Mar. 3, 1992 to Bedol, shows a clip-on calculator assembly comprising a thin calculator housing containing a calculator and a thin resilient clip disposed about the outer periphery of the calculator housing. The clip is integrally connected to a portion of the calculator housing. Spaces are formed between the outer periphery of the housing and the resilient clip for allowing paper or the like to be positioned between the outer periphery and the resilient clip, thereby clipping the same to the calculator. The clip-on calculator may be conveniently used as a page marker for date books, checkbooks, etc.

U.S. Pat. No. D348,897, issued Jul. 19, 1994 to Bedol, claims the ornamental design for a clip-on calculator.

U.S. Pat. No. 7,227,528, issued Jun. 5, 2007 to Goszyk, describes a thin electronic reference device is that can be used by a user when reading a book. The electronic reference device functions as a dictionary for the reader to look up words as they read. It can also have various other functions that would be suitable for a portable electronic device. The device has a main body that houses a display and a keyboard section. The main body is thin enough to be able to fit between the pages of the book. The top of the device is slightly larger than the main body and the battery is not housed in the main body.

U.S. Pat. No. 5,073,054, issued Dec. 17, 1991 to McDowell, indicates an electronic dictionary or language translator having a vertical keyboard. The housing of the thin electronic device is preferably at least 3″.times.6″ in size so that it may be placed in a book and used during reading. The electronic device has a relatively large display area and its keys are spread apart so that they may be readily operated by the fingers of either hand. The device utilizes a specially arranged keyboard with an alphabetical sequence of the letters, but with the vowels positioned so that they start and end each row. In addition, certain vowels are repeated both on the left and right sides of the keyboard.

U.S. Pat. No. 5,365,434, issued Nov. 15, 1994 to Figliuzzi, concerns a book enhancer for inputting of a portion of a word or problem on a specific page of a book for assisting the reader of the book in understanding the term as it is being used in the book. An interchangeable memory is inserted into the system corresponding to the book which is being read. An interchangeable or permanent system memory is further provided for storing commonly used words or problems with respect to the subject matter of the book therein. The system operates by inputting a page number and a portion of a word or problem in the book into the system, and the system matches this portion on the specific page with a word or problem in its memories. The word and definition may then be output by the system so that the reader understands the word or problem as it is being used. In addition, alternate definitions of the word or similar problems to the problem which is output may be provided to the reader for further aid in comprehension. The system may include a “bookmark” function such that when the user stops reading the book at a particular point therein, the user designates the point at which he stops, and that point is displayed on the screen of the system after initialization is performed when the book is again picked-up for reading by the user.

What is needed is a portable electronic bookmark which is releasably secured to a book cover for indicating to a user any of a number of book references or other printed work references and any of a number of referenced pages within each book reference as a means for a reader to re-access desired pages in desired books or other printed works.

### BRIEF SUMMARY OF THE INVENTION

An object of the present invention is to provide a portable electronic bookmark which is releasably secured to a book cover for indicating to a user any of a number of book references or other printed work references and any of a number of referenced pages within each book reference as a means for a reader to re-access desired pages in desired books or other printed works.

A related object of the present invention is to provide an electronic bookmark which may hold a plurality of titles and page numbers and which comprises a thin planar housing with an alphanumeric keypad, a book title display, a digital page number display, a title insert key, a title lock key, a reference key, a recall key, and a book select key on a front face thereof and one or more high tension mounting spring clips on a back face thereof as well as a battery compartment for a convenient reference which may be carried in a pocket or purse or clipped onto a book.

In brief, a portable electronic bookmark which may be releasably secured to a book cover for indicating to a user the location where the user was previously reading in a piece of literature having a plurality of pages; the electronic bookmark may hold a plurality of titles and page numbers and comprises a thin planar housing with an alphanumeric keypad, a book title display, a digital page number display, a title insert key, a title lock key, a reference key, a recall key, and a book select key on a front face thereof and one or more high tension mounting spring clips on a back face thereof.

An advantage of the present invention is that it provides any of a number of book references or other printed work references and any of a number of referenced pages within each book reference as a means for a reader to re-access desired pages in desired books or other printed works in a convenient thin casing which may be carried in a pocket or purse or clipped onto a book.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a front elevational view of the electronic multiple reference bookmark device of the present invention showing the front face with a digital display, an alphanumeric keypad, and control buttons;

FIG. 2 is a back elevational view of the electronic multiple reference bookmark device of FIG. 1 showing the back face with book attaching clips and a battery compartment;

FIG. 3 is a back perspective view of the electronic multiple reference bookmark device of FIG. 1 showing the back face with the book attaching clips and the battery compartment;

FIG. 4 is a front elevational view of the electronic multiple reference bookmark device of the present invention showing an alternate front face with two digital displays, an alphanumeric keypad, and control buttons.

### DETAILED DESCRIPTION OF THE INVENTION

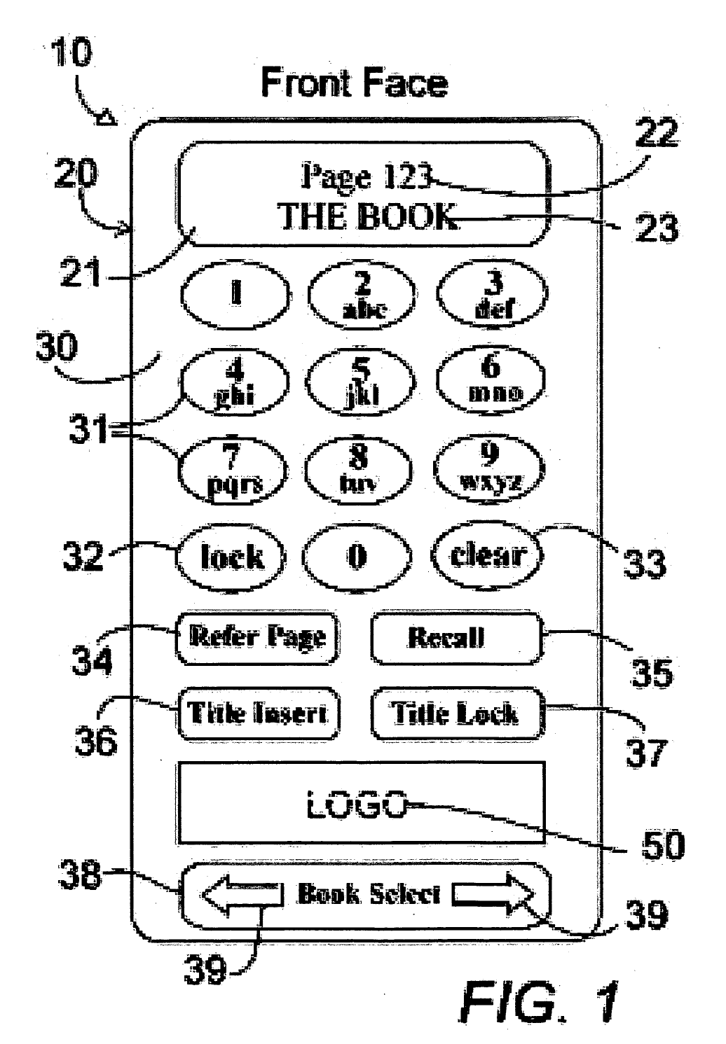

In FIGS. 1-4, a portable electronic multiple reference bookmark device 10 comprises a thin case 20 which may be carried in a pocket or purse or clipped to a book, the case having an internal electronic device including memory and an external keyboard 31 and digital display 21, 21A, and 21B for saving and displaying information related to multiple references to printed works and multiple relevant pages to each of the printed works as a substitute for bookmarks in the books or other printed works, which are messy, can slip out, and often damage the works if they discolor the pages or otherwise harm the pages, especially if they are too thick.

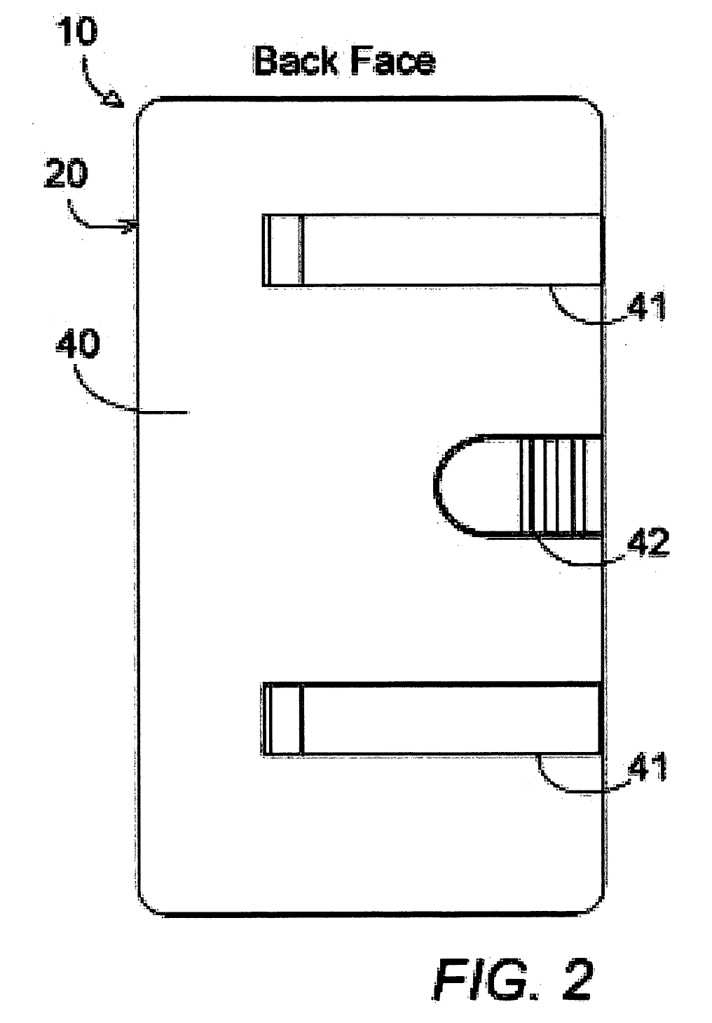

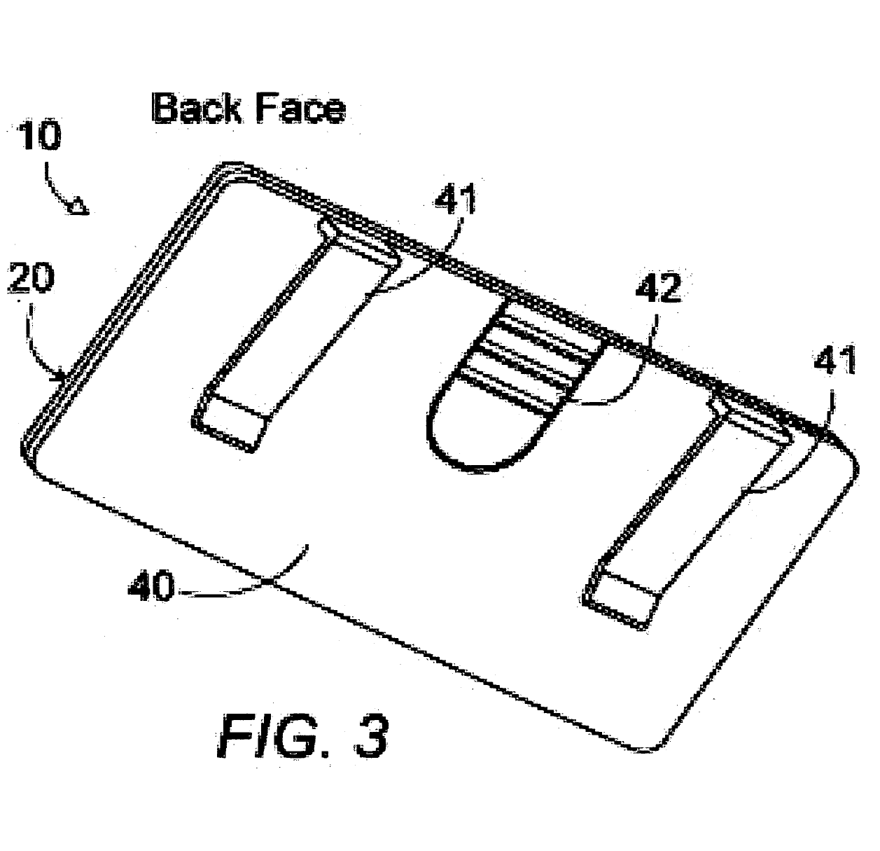

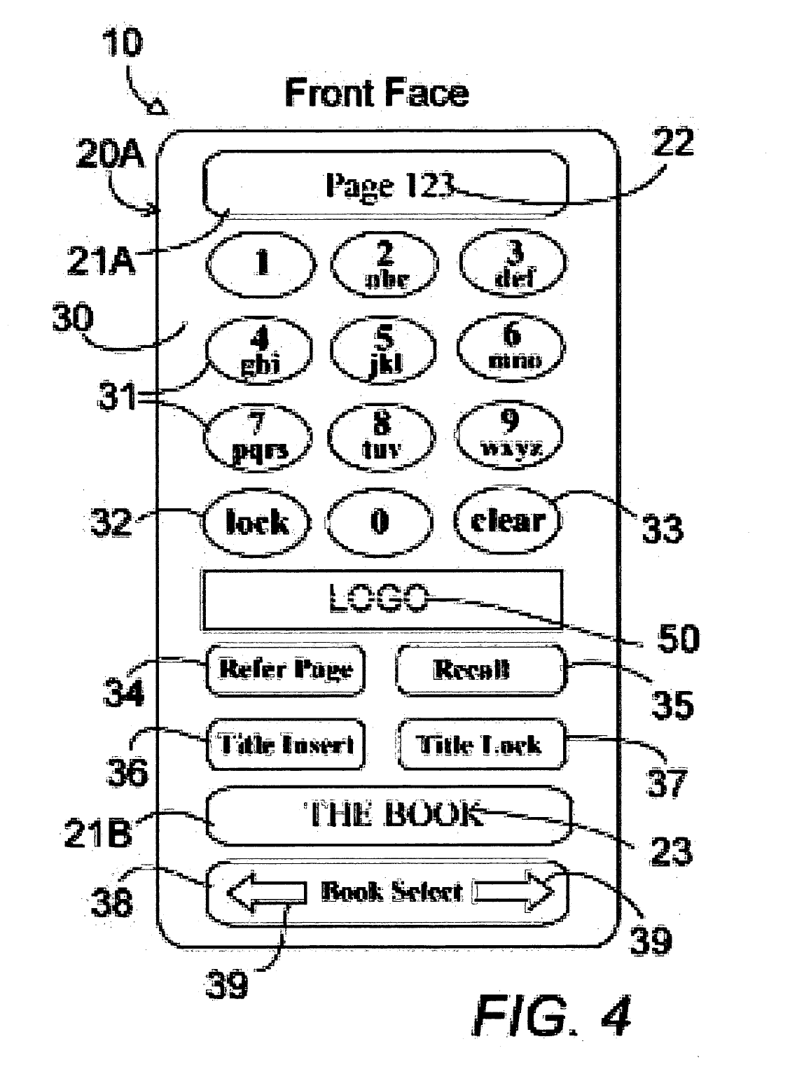

The handheld thin planar case 20 and 20A has a front face 30, as shown in FIGS. 1 and 4, and a back face 40, as shown in FIGS. 2 and 3, and houses a programmable electronic device for receiving, storing, and retrieving reference information for a multiplicity of references to printed works and a multiplicity of page references for each of the multiplicity of references to printed works. An alphanumeric keypad 31 is located on the front face of the case for inputting references to printed works and related page references information to the programmable electronic device. One digital display 21 in FIG. 1 and two digital displays 21A and 21B in FIG. 4 on the front face of the case display any of the multiplicity of references to printed works 23, such as a book title, and a multiplicity of related page references 22 for each of the references to the printed works as well as operational information.

In FIGS. 1 and 4, a book reference insert key 36, entitled “Title Insert” in FIGS. 1 and 4, on the front face 30 of the case 20 activates the keypad 31 and the at least one digital display 21 and 21A and 21B to enable inputting any of a plurality of references to printed works 23 into the electronic device which is displayed on the digital display 21 or 21B. A title lock key 37, entitled “Title Lock” on the front face 30 of the case 20 saves the references to printed works 23 in the memory of the electronic device.

In FIGS. 1 and 4, a page reference key 34, entitled “Refer Page” on the front face of the case is used for inputting a page reference typed into the keypad 31 for a printed work reference that is indicated on the at least one digital display 21 and 21B for saving the page reference 22 to the electronic device. A book selection key 39, entitled “Book Select” on the front face 30 of the case 20 is used for activating the electronic device to display any of the plurality of saved references to printed works 23 on the at least one digital display 21 and 21B selected from a list of saved references to printed works 23 by scrolling through the list using scroll arrows 39. A recall key 35, entitled “Recall” on the front face 30 of the case 20 is used for activating the electronic device to display any of a plurality of saved page references 22 to the printed work reference indicated on at least one digital display 21 and 21A.

In FIGS. 2 and 3, a battery housing 42 and one or more, preferably two, high tension mounting spring clips 41 on a back face 40 of the case 20 engage a book cover or clothing or a belt of a user for transporting the device.

A means for activating and deactivating the device on one of the sides of the case may comprise a key in a portion of the front face of the case bearing a logo 50 for activating and de-activating the device.

Each one of the keys of the keypad is preferably programmed in the programmable electronic device to activate the programmable device to display the last displayed referenced printed work and the last displayed related referenced page on the digital display upon depressing any of the keys when the device is activated.

The digital display screen 21, 21A, and 21B is preferably programmed to go blank after 30 seconds of non-use to conserve the battery.

The device preferably is powered by a battery (CR2025 lithium) stored in the battery compartment 42 of the back face 40 of the case 20 for the needed power.

In use, multiple references to printed works 23 such as books and relevant page references of each of the printed works can be saved for reference. A book title is saved by depressing the book title insert key 36 and typing the title using the alphanumeric keys 31. After the book title reference 23 is displayed in the digital display 21 and 21B, in this case “THE BOOK”, the title lock key 37 is depressed for three seconds. The title 23 will flash three times and the page display 22 will read “0000”.

To add another book into the device, depress the scroll arrows 39 on the book select key either direction until the book or other reference to a printed work 23 and the page reference 22 in the digital display 21, 21A, and 21B are both blank. Then insert the new book reference in the device as indicated above, or depress the title insert key 36 and proceed with above instructions. The memory is capable of storing numerous references to printed works and numerous reference pages.

If the power is off, and any key is depressed, the last referenced title reference of a printed work 23, and the last locked related reference page 22 will be displayed in the digital display 21, 21A and 21B. This allows the user to save other reference pages in the same file.

To save a page number for reference at a later time, the correct title or other reference of the printed work 23 is displayed in the digital display 21 and 21B, the related page reference or references 22 are input on the alphanumeric keys 31, the Reference key 34 is depressed for three seconds, and the page reference 22 will flash to ensure the page is stored. This procedure is repeated for multiple reference pages. To recall a page, the correct title is displayed and the Recall button 35 is depressed. The first saved reference page 22 will be displayed. The Recall button 35 is depressed again to advance to the next saved page for said title shown in display 23.

The portable electronic multiple reference bookmark device 10 of the present invention may be releasably secured to a book cover using clamps 41 for indicating to a user the location where the user was previously reading in a piece of literature having a plurality of pages.

When the reader stops reading a book, the correct book title or other reference to a printed work 23 is displayed and the page number of the book is input into the digital display 21 and 21A, the lock key 32 is depressed for 3 seconds; the reference page display 22 will flash 3 times to confirm the page is locked in for the book.

To delete a book, the correct book title 23 is displayed, and the clear key 33 is depressed for 3 seconds. This will erase all stored information for that book only. The reference page display 22 will read “0000” and the book title display 23 will go blank.

The book select key 38 arrows 39 are also function keys when the device is in the “Title Insert” 36 mode. While the user is inputting book titles utilizing the alphanumeric keys 31 the arrow left 39 can be used to back up characters to correct errors, while the arrow right 39 key can be used to advance characters to leave spaces in the title display 23.

The case 20 is preferably fabricated of durable plastic or metal and the back face 40 has two high tension spring clips to secure the device to a book. The dimensions of the invention and design may be of any size, color or style.

It is understood that the preceding description is given merely by way of illustration and not in limitation of the invention and that various modifications may be made thereto without departing from the spirit of the invention as claimed.

What is claimed is

1. A portable electronic multiple reference bookmark device comprising:
a handheld thin planar case having a front face and a back face, the case housing a programmable electronic device for receiving, storing, and retrieving reference information for a multiplicity of references to printed works and a multiplicity of page references for each of the multiplicity of references to printed works; an alphanumeric keypad on the front face of the case for inputting references to printed works and related page references information to the programmable electronic device; at least one digital display on the front face of the case for displaying any of the multiplicity of references to printed works and related page references and operational information; a book reference insert key on the front face of the case for activating the keypad and the at least one digital display to enable inputting any of a plurality of references to printed works into the electronic device; a title lock key on the front face of the case for saving references to printed works in the electronic device; a page reference key on the front face of the case for inputting a page reference typed into the keypad for a printed work reference that is indicated on the at least one digital display for saving the page reference to the electronic device; a book select key on the front face of the case for activating the electronic device to display any of the plurality of saved references to printed works on the at least one digital display; a recall key on the front face of the case for activating the electronic device to display any of a plurality of saved page references to the printed work reference indicated on the at least one digital display; a battery housing and one or more high tension mounting spring clips on a back face of the case; and means for activating and deactivating the device on one of the sides of the case.

2. The device of claim 1 wherein each one of the keys of the keypad is programmed to activate the programmable device to display the last displayed referenced printed work and the displayed related referenced page on the digital display upon depressing any of the keys when the device is activated.

3. The device of claim 3 wherein the portion of the front face of the case bearing a logo further comprises a key which is the means for activating and deactivating the device.
